(19) United States
(12) Patent Application Publication
(10) Pub. No.: US 2010/0228943 A1
(43) Pub. Date: Sep. 9, 2010

(54) ACCESS MANAGEMENT TECHNIQUE FOR STORAGE-EFFICIENT MAPPING BETWEEN IDENTIFIER DOMAINS

(75) Inventors: Sanjay Deshpande, Austin, TX (US); Jaideep Dastidar, Austin, TX (US)

Correspondence Address: ZAGORIN O'BRIEN GRAHAM LLP (115), 7600B N. CAPITAL OF TEXAS HWY., SUITE 350, AUSTIN, TX, 78731-1191, US

(73) Assignee: FREESCALE SEMICONDUCTOR, INC., Austin, TX (US)

(21) Appl. No.: 12/398,099

(22) Filed: Mar. 4, 2009

(51) Int. Cl. G06F 12/06

(52) U.S. Cl. 711/206; 711/E12.078

(57) ABSTRACT

Access management techniques have been developed to specify and facilitate mappings between I/O and host domains in ways that are storage-efficient and which can provide flexibility in the form, granularity and/or extent of mappings, attributes and access controls coded relative to a particular I/O domain. Indeed, different identifier and/or operation translation models may be employed on a per logical device (or even a per sub-window) basis. In general, the flexibility and efficiency afforded using some embodiments of the present invention can be desirable, particularly as numbers of I/O domains increase, such as in the case of virtualization system implementations in which a multiplicity of logical I/O devices may be represented using underlying physical resources.

### CROSS-REFERENCE TO RELATED APPLICATION(S)

The present application is related to commonly owned U.S. application Ser. No. ______ {Docket No. NM45493THX}, filed on even date herewith, entitled “Access Management Technique with Operation Translation Capability” and naming Deshpande and Dastidar as inventors.

### BACKGROUND

1. Field

This disclosure relates generally to data processing systems, and more specifically, to peripheral or input/output (I/O) management techniques whereby addresses or other identifiers are mapped from one domain to another.

2. Related Art

In a computational system that is divided into multiple independent logical partitions, each including computing resources (e.g., processor cores), storage resources and input/output (I/O) resources, mechanisms are often needed to isolate partitions from each other so that one partition's processors and I/O devices do not inappropriately access another partitions' storage and I/O resources. In general, isolation mechanisms may be deployed with respect to physical resources or virtual resources exposed from underlying physical resources. For example, isolation of memory address spaces (e.g., in a multiprocessor or in a virtualization system that exposes multiple virtual processors) is typically achieved using a memory management unit (MMU) that maps virtual memory addresses to physical memory using page table entries that limit the visibility of the processor to partition's own resources. Isolation mechanisms can also be employed with respect to I/O transactions (or accesses) in devices or functional blocks commonly known as IOMMUs or peripheral access management units (PAMUs).

An access management unit implementation, whether styled or deployed as an MMU, IOMMU or PAMU, typically employs storage for representation of its mapping model. Unfortunately, as the number of address domains (or more generally, identifier domains) mapped increases and/or as the flexibility or number of mapping techniques available increases, mapping data storage requirements tend to increase as well. Accordingly, storage efficient mapping data representations and techniques are desired.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a computational system in which addresses or other identifiers are mapped between an input/output (I/O) interconnect domain and a coherency domain using a peripheral access management unit (PAMU) in accordance with some embodiments of the present invention.

FIG. 2 depicts a peripheral access management unit (PAMU) of a host bridge suitable for positioning astride the boundary between an I/O domain and a coherency domain.

FIG. 3 depicts use of a first-level peripheral access authorization and control table (PAACT) by a peripheral access management unit (PAMU) in accordance with some embodiments of the present invention.

FIGS. 4 and 5 show illustrative organizations of peripheral access authorization and control entries (PAACEs) that may be employed, in accordance with some embodiments of the present invention, in first- and second-level peripheral access authorization and control tables (PAACTs), respectively.

FIG. 6 depicts use of first- and second-level peripheral access authorization and control tables (PAACTs) to present for a particular logical I/O device a set of sub-windows that together define mappings between address or identifier domains in accordance with some embodiments of the present invention.

FIG. 7 illustrates mapping from an I/O address space to a memory address space via peripheral access authorization and control entries (PAACEs) represented in first- and (in some illustrated cases) second-level peripheral access authorization and control tables (PAACTs).

The use of the same reference symbols in different drawings indicates similar or identical items.

### DESCRIPTION OF THE PREFERRED EMBODIMENT(S)

Access management techniques have been developed to specify and facilitate mappings between I/O and host domains in ways that are storage-efficient and which can provide flexibility in the form, granularity and/or extent of mappings, attributes and access controls coded relative to a particular I/O domain. Indeed, different identifier and/or operation translation models may be employed on a per-logical-device (or even a per-sub-window) basis. In general, the flexibility and efficiency afforded using some embodiments of the present invention can be desirable, particularly as numbers of I/O domains increase, such as in the case of virtualization system implementations in which a multiplicity of logical I/O devices may be represented using underlying physical resources.

Accordingly, in some embodiments, rather than attempting to create a unified set of access, authorization and/or control information for mappings between all I/O and host domains (or even a unified mapping for subsets of the I/O domains corresponding to logical I/O devices supported using common underlying resources), each logical I/O device may be supported with information that need only encode that pertinent thereto and then, only in a manner that is useful or efficient for the particular logical I/O device and its relevant mappings. Of course, in accord with the flexibility provided, mappings for disparate I/O domains may optionally be encoded in like manner (e.g., with similar or identical form, granularity, extent and/or identifier translation model), but need not be synthesized into a unified mapping.

In some systems that incorporate embodiments of the present invention, the ability to encode access, authorization and/or control information on a per-logical-device basis (or even a per-sub-window basis with a given I/O domain) facilitates coding of the mappings in ways that are, in aggregate, quite storage-efficient as the coding for one I/O domain need not be fettered by complexity necessary or desirable only for another and since no grand unification of mappings is necessary. In short, by defining mapping data structure(s) in a way that allows differing complexity, granularity and/or extent of mapping for individual logical I/O domains, system implementations need not code all mappings in accord with requirements of the most complex or storage intense. In this way, scaling of overall storage requirements may be managed in access management system implementations. In addition, in some embodiments, the form of mappings (e.g., address) may be specialized on a per-logical-device basis (or per-sub-window basis), thereby offering individual logical I/O domains (or sub-windows thereof) paged, windowed, mixed, and/or untranslated mapping frameworks appropriate to their individual requirements or needs.

For concreteness of description, we focus on certain illustrative implementations of a peripheral access management unit (PAMU) in a logically partitionable, multiprocessor-based computational system for which a multiplicity of logical I/O devices and domains are supported using underlying physical resources. Typically, operating system images are instantiated in individual partitions and one or more PAMU instances mediate address mappings between I/O domains and a coherency domain of the system. In general, the illustrative implementations include support for a range of variations in form, granularity and/or extent of mappings as well as support for access and authorization controls and other features that need not be included in all embodiments. Accordingly, based on the description herein, persons of ordinary skill in the art will appreciate applications of the invented techniques to other access management systems (including those styled as MMUs, PAMUs, IOMMUs, etc.) and to computational systems without virtualization, multiprocessors support or partitionable aspects.

For generality, the illustrated implementations are described in a manner that is generally agnostic to design details such as instruction set architecture, I/O device types, operating system conventions, memory model, interconnect technology, communication or data transfer protocols and access/authentication mechanisms employed. Where useful to provide concreteness of description, certain illustrative designs may be described, though generally without limitation. Techniques described herein have broad applicability to other access management and to other address or identifier mapping systems, but will be understood and appreciated by persons of ordinary skill in the art in the illustrated context. Accordingly, in view of the foregoing and without limitation on the range of access management techniques, underlying processor or system architectures, and mapping domains that may be employed in embodiments of the present invention, we describe certain illustrative embodiments.

### System and Integrated Circuit Realizations, Generally

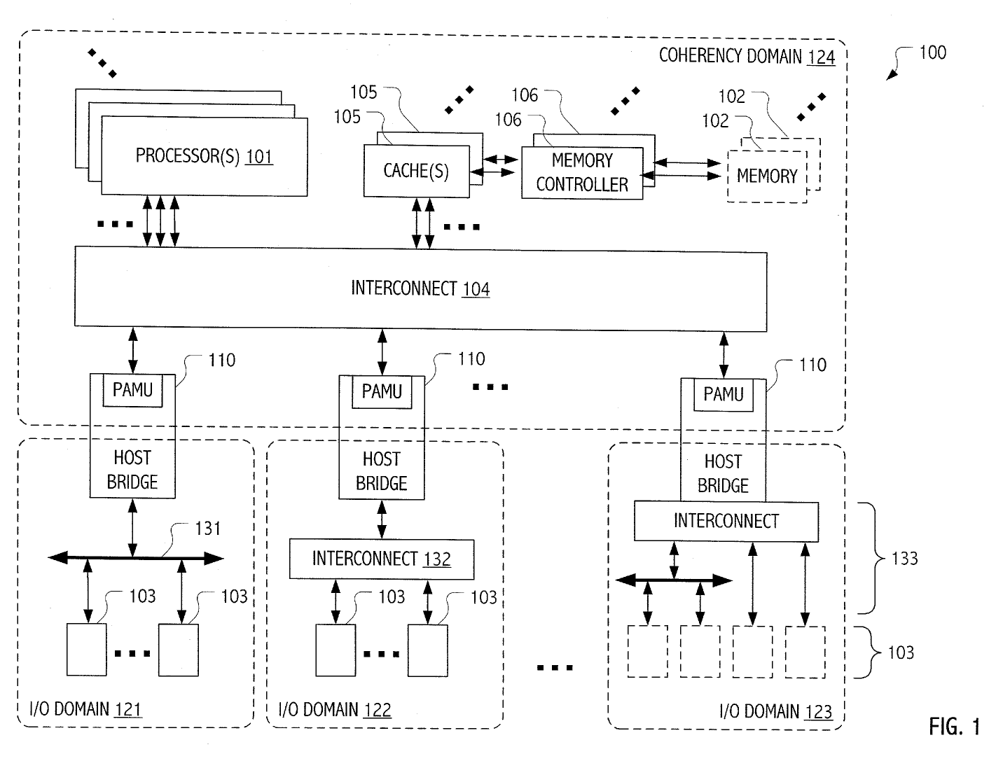

FIG. 1 illustrates a computational system 100 in which addresses or other identifiers are mapped between various input/output (I/O) interconnect domains (e.g., I/O domains 121, 122 and 123) and a coherency domain 124 using respective peripheral access management units (PAMUs) in accordance with some embodiments of the present invention. Computational system 100 includes processors 101, memory 102 and I/O devices 103 coupled by an interconnect 104. Although any of a variety of memory hierarchies may be employed, FIG. 1 illustrates a configuration in which at least some level of cache 105 is interposed between interconnect 104 and memory 102 (and associated memory controllers 106). In some embodiments, caches 105 are configured as L3 cache and represent state that spans the data and instruction spaces of processors 101, while additional levels of L1 and L2 cache (not separately shown) are collocated with individual processors or processor cores.

In the illustrated configuration, interconnect 104 includes a scalable on-chip network that is suitable for interconnecting multiple processor cores with memory and I/O subsystems. Processors 101 are linked to each other, to memory 102 and host bridges 110 via the interconnect 104 and, in some embodiments, interconnect 104 implements a modern front-side multi-path interconnect fabric that supports concurrent non-conflicting transactions and high data rates. However, in other embodiments, a conventional front-side bus may be employed as interconnect 104.

In the illustrated configuration, I/O devices 103 do not connect directly to primary processor busses, but rather via respective host bridges 110. In general, any given I/O device 103 attaches to an I/O interconnect, such as PCI Express, AXI or other interconnect technology, and has a set of resources appropriate to its function. For generality, bus-type interconnects 131, multiplexed interconnects 132 and mixed-type interconnect configurations 133 are all illustrated. Operations that involve an I/O device 103 may include:
I/O operations: storage operations initiated from within coherency domain 124 which cross the coherency domain boundary,
direct memory access (DMA) operations: storage operations initiated from outside coherency domain 124 that target storage (e.g., memory 102) within the coherency domain, and
direct peer access (DPA) operations: storage operations initiated outside coherency domain 124 that target storage that is also outside the coherency domain.
   Thus, a wide variety of I/O devices is contemplated, including devices that support DMA and/or DPA operations. For purposes of illustration, and without limitations as to operation supported, an I/O device 103 tends to initiate read/write-type operations and may be the target of read/write-type operations initiated by processors (e.g., processors 101) and/or other I/O devices. Of course, more complex sets of operations may be supported in some embodiments and will be appreciated by persons of ordinary skill in the art based on the description herein.

In some embodiments, a substantial portion of a computational system such as illustrated in FIG. 1 is implemented as a system on a chip (SoC) and embodied as a single integrated circuit chip. In such configurations, memory and/or a subset of I/O devices or interfaces may be implemented on- or off-chip, while the substantial entirety of illustrated blocks are packaged as an SoC. However, in other embodiments and more generally, portions of computational system 100 may be implemented in or as separate integrated circuits in accord with design packaging or other requirements.

In some embodiments, computational system 100 is configured as a partitionable multiprocessor system in which storage operations involving I/O devices may be confined to a particular partition (or partitions) to which they correspond. In such embodiments, isolation of partitions may be achieved using device authorization mechanisms and address and operation type checking may be performed using respective peripheral access management units (PAMUs). Although not essential to all embodiments, flexible, even dynamic, partitioning of underlying hardware may be facilitated using modern virtualization technologies (e.g., hypervisors) that execute on underlying resources of computational system 100 (e.g., processors 101, memory 102 and I/O devices 103) and expose fractional portions thereof to guest computations (e.g., operating system instances and applications) as virtual machines or partitions. Virtualization technologies are widely employed in modern computational systems and, particularly with regard to processor and memory virtualization, suitable designs and the operation thereof are well understood by persons of ordinary skill in the art. In some embodiments, a firmware-based hypervisor is employed.

Focusing illustratively on I/O virtualization, it is worth noting that underlying physical I/O devices 103 are typically virtualized as a multiplicity of logical I/O devices (LIODs) presented to software executing on computational system 100 (or on virtual machines thereof). In this way, each logical I/O device has its own programming/operation interface and view of the system storage space. In general, this view extends only to those limited portions of large system and peripheral memory spaces (within coherency domain 124) and I/O address/identifier spaces (within the I/O domains 121, 122 . . . 123) that are pertinent to operation of the particular logical I/O device and current partition state of computational system 100. In general, a given I/O device 103 may present as multiple logical I/O devices and, conversely, multiple I/O devices 103 may present as a logical I/O device.

In the illustration of FIG. 1, coherency domain 124 spans the collection of memory subsystems including memory 102 and caches (e.g., the illustrated L2/L3 caches 105 and any other caches or lookaside stores), processors 101, interconnect 104, and I/O host bridges 110 that cooperate through relevant protocols to meet memory coherence, consistency, ordering, and caching rules specific to a platform architecture. For example, in some embodiments, coherency domain 124 conforms to coherence, consistency and caching rules specified by Power Architecture™ technology standards as well as transaction ordering rules and access protocols employed in a CoreNet™ interconnect fabric. Power Architecture is a trademark of Power.org and refers generally to technologies related to an instruction set architecture originated by IBM, Motorola (now Freescale Semiconductor) and Apple Computer. CoreNet is a trademark of Freescale Semiconductor, Inc.

Memory addresses can be used to identify storage locations within (or from the perspective of) coherency domain 124. Typically, a system memory portion of this coherency domain address space is used to address locations in memory 102, while a peripheral memory portion of the coherency domain address space is used for addresses that processors 101 view as assigned to I/O host bridges 110. Using facilities of respective peripheral access management units (PAMUs), the I/O host bridges translate between coherency domain addresses and addresses (or identifiers) for particular I/O devices within corresponding ones of the I/O domains (e.g., I/O domain 121, 122 or 123). As the number and diversity of I/O devices scales, complexity of mapping and related access and authorization controls can increase dramatically. Furthermore, since a multiplicity of logical I/O devices may be virtualized in accord with system partitioning, scaling challenges can further strain conventional mapping techniques. Techniques now described with reference to peripheral access management unit (PAMU) facilities of the I/O host bridges 110 seek to address these or other challenges.

### Peripheral Access Management Unit (PAMU)

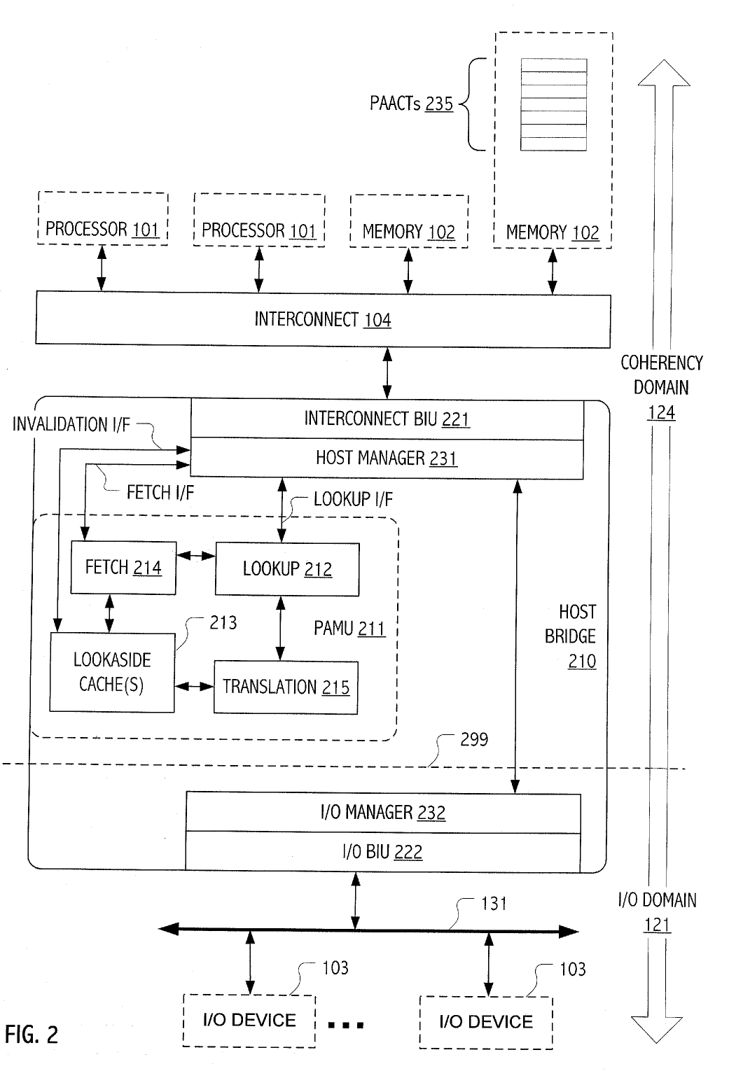

FIG. 2 depicts a peripheral access management unit (PAMU) of host bridge 210 positioned astride a boundary 299 between an I/O domain and a coherency domain. In the illustrated configuration, PAMU 211 maps between identifiers used by I/O devices 103 within I/O domain 121 and identifiers used within coherency domain 124. Typically, identifiers in I/O domain 121 are styled as device or I/O addresses and identifiers in coherency domain 124 include physical addresses in memory 102.

In general, host bridge 210 couples to interconnect technologies employed in respective domains that it bridges and in accord with any operative interface protocols and conventions. In the illustrated configuration, respective bus interface units (e.g., interconnect BIU 221 and I/O BIU 222) implement the appropriate transaction protocols. In the case of interconnect 104 and BIU 221, a split transaction model is supported with independent address, response and data paths, together with a transaction ordering and coherence framework. In general, read and write operations are implemented as a series of interconnect transactions and host bridge 210 acts as both a requestor and target for transactions (and operations) transacted via interconnect 104. In the illustrated configuration, full real address width address transactions (e.g., 64-bit in some embodiments) are supported. In the case of I/O bus 131 and BIU 222, any of a variety of interconnect technologies and transaction models, (including PCI Express, AXI, etc.) may be supported. Design and operation of suitable bus interface units are well understood in the art. BIUs 221 and 222 are of any suitable designs.

Host manager 231 and I/O manager 232 receive operations such as read and write operations from traffic transacted by respective BIUs and interact with each other to effectuate, in a respective one of coherency domain 124 and I/O Domain 121, operations initiated in the other. For example, host manager 231 may receive a write-type operation from coherency domain 124, recognize the operation as destined for an I/O device within I/O Domain 121 and supply a corresponding mapped operation to I/O manager 232 for transacting via I/O bus 131 and completion on an appropriate I/O device 103 instance. Similarly, I/O manager 232 may receive a read-type operation from an I/O device 103 of I/O Domain 121, recognize the operation as destined for memory 102 in coherency domain 124 and supply same to host manager 231 for transaction via interconnect 104. Return path read data may then flow back (through interconnect 104, BIU 221, host manager 231, I/O manager 232, BIU 222 and I/O bus 131) to the requesting I/O device 103 instance.

In the illustrated configuration, coherence transactions or operations such as CPU initiated barrier transactions and snoop transactions for invalidation of mapping entries are also supported. More generally, a wide variety of suitable variations on techniques for bridging domains will be understood by persons of ordinary skill in the art. Accordingly, the foregoing examples are for illustrative purposes only and, based on the description herein, persons of ordinary skill in the art will appreciate numerous variations on operation-type, flow, sense and sequencing appropriate to a given implementation, I/O device suite, interconnect technology, coherence model and/or instruction set architecture.

Turning now to PAMU 211, operations that bridge the boundary 299 between coherency domain 124 and I/O Domain 121 can, and typically do, require some sort of mapping between identifier domains. In addition, in some embodiments, authorization checks, operation translations, and other controls or transformations may be performed incident to the mapping. In the illustration of FIG. 2, PAMU 211 performs mappings (and any operative controls or transformations) based on lookups against peripheral access authorization and control tables (PAACTs 235), which are initiated by host manager 231 in the course of bridging operations (in either direction) between coherency domain 124 and I/O Domain 121. In general, entries of such tables are represented (at least in primary form) in memory 102 of coherency domain 124 and are at least partially cached in storage local to PAMU 211.

In general, by deploying PAMU 211 (here, integrated with host bridge 210), a computational system obviates the need for I/O devices 103 to directly address physical memory and allows large (in the aggregate) discontiguous regions of physical memory to be employed in I/O transfers, while I/O devices can be presented with respective virtual address spaces that may be compact and contiguous. Indeed, PAMU 211 allows virtual (I/O domain) to physical (coherency domain) mappings to be presented on a per I/O device, or per logical I/O device, basis. Note that in partitioned or virtualization based systems, a guest operating system will not typically have access to underlying virtual-to-physical memory address mappings. Accordingly, it may be quite difficult for the guest operating system to manage direct memory access (DMA). PAMU 211 facilitates use of partitioning and/or virtualization techniques by providing a mapping mechanism configurable using in-memory tables. In this way, a hypervisor or virtualization system maintains virtual-to-physical mappings between I/O and coherency domain identifiers (much in the same way it may maintain shadow page tables for mappings between guest virtual addresses and underlying physical memory addresses) and delegates the mapping function for individual accesses or operations to PAMU 211.

In the illustration of FIG. 2, virtual-to-physical mappings between I/O and coherency domain identifiers are represented in peripheral access authorization and control tables (PAACTs 235) which reside in memory 102. As the total number of I/O devices and/or logical I/O devices grows, the number of entries not pertinent to any particular physical or logical I/O device can likewise scale. Accordingly, to reduce latencies, PAMU 211 coherently caches contents of peripheral access authorization and control entries (PAACEs) that encode identifier mappings and related controls or transformations for I/O operations, direct memory access (DMA) operations, and/or direct peer access (DPA) operations that involve I/O Domain 121. Accordingly, for a given access (e.g., a read- or write-type access initiated from I/O Domain 121), host manager 231 seeks to obtain (for a particular logical I/O device) the appropriate mapping between an I/O Domain 121 side identifier and a coherency domain 124 side memory address.

Host manager 231 enlists PAMU 211 in that lookup, e.g., using a logical I/O device number (LIODN) and I/O domain address to identify relevant entries in peripheral access authorization and control tables. Lookup unit 212 traverses peripheral access authorization and control tables and returns relevant mapping information (and optionally, operation translation information) to host manager 231 for use in initiating appropriate transactions in interconnect 104 to access mapped locations in memory 102. If the relevant traversal can be performed and if relevant access authorization and control entries can be retrieved from lookaside cache 213, then lookup unit 212 may efficiently satisfy PAMU 211 without walking peripheral access authorization and control tables in memory 102 (e.g., PAACTs 235). If not, fetch unit 214 coordinates retrieval of relevant peripheral access authorization and control entries (PAACEs) from memory 102 to satisfy the lookup. PAMU 211 also provides an invalidation interface to allow cached PAACEs to be invalidated in accord with a suitable PAACTs coherence protocol.

In some embodiments, translation unit 215 is also provided to support translation of source operation types to destination operation types in accord with contents of relevant PAACEs. As with identifier/address mappings, operation translations are based on functionally descriptive information coded in memory resident tables that may be cached in cache 213. Operation translation techniques are described in greater detail in U.S. application Ser. No. ______ {Docket No. NM45493THX}, filed on even date herewith, entitled “Access Management Technique with Operation Translation Capability” and naming Deshpande and Dastidar as inventors, the entirety of which is incorporated herein by reference.

### Peripheral Access Authorization and Control Tables (PAACTs)

Operation of PAMU 211 will be understood with reference to the structure and coding of peripheral access authorization and control tables (PAACTs) and peripheral access authorization and control entries (PAACEs) thereof. PAACTs are memory-resident data structures initialized and maintained by supervisory code (e.g., by a hypervisor in a computational system that employs partitioning or virtualization) and used by PAMU 211.

A PAACT is a table of PAACEs, which each encode access rights afforded a logical I/O device. A logical I/O device number (LIODN), which is typically signaled with a logical I/O device access, is used to identify a corresponding PAACE from the PAACT. Direct storage access operations (DSA operations, including memory access and direct peer access operations) performed by logical I/O devices are typically associated with a computational system partition and are allocated a portion (or DSA window) of I/O interconnect address space. The DSA window, in turn, corresponds to one or more regions of storage (e.g., memory 102) in the coherency domain. A PAACE identifies and codes the extent of the DSA window that is allocated and accessible to the corresponding logical I/O device. Typically, only accesses within the corresponding DSA window are authorized for the logical I/O device. Also, a logical I/O device may be subject to restrictions as to the type of DSA operations it is allowed to perform. In general, attributes that define access restrictions/permissions for a particular logical I/O device are coded in a corresponding PAACE.

In general, a logical I/O device may be allowed to access multiple windows. Accordingly, for at least some logical I/O devices, this multiplicity of windows (and their corresponding access authorization controls, address/identifier mappings and, in some embodiments, operation translations) is coded in a two-level hierarchy, whereby a DSA window spans multiple sub-windows (e.g., 2ⁿ equal sized sub-windows) defined within the DSA window. The first sub-window is referred to as the primary sub-window and the remaining ones are secondary sub-windows. The DSA window defines the overall address range within which the one or more sub-windows reside.

Building on the foregoing, in some embodiments in accordance with the present invention, functionally-descriptive information for the DSA window corresponding to a particular logical I/O device is encoded in a primary PAACE of a first-level PAACT. For some logical I/O devices, one or more secondary PAACEs from a second-level PAACT encode additional functionally-descriptive information relative to constituent secondary sub-windows. For the primary (or in some cases, sole) sub-window, access authorization controls, address/identifier mappings and, in some embodiments, operation translations are coded in the primary PAACE, whereas for secondary sub-windows (if any), access authorization controls, address/identifier mappings and, in some embodiments, operation translations are coded in respective secondary PAACEs.

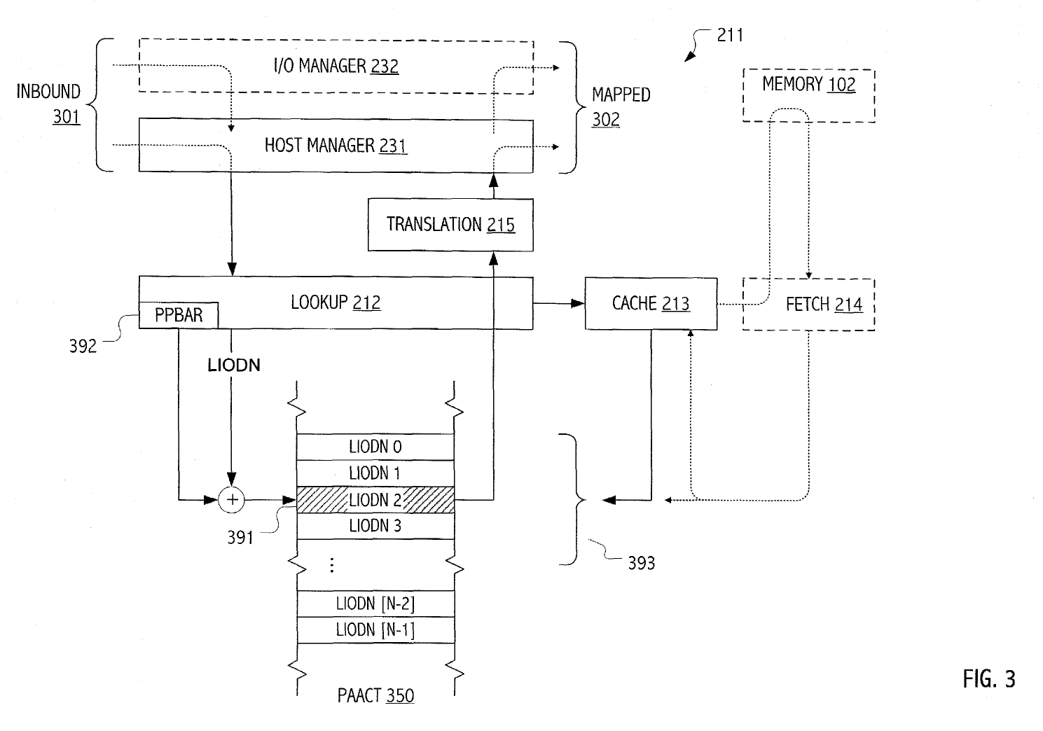

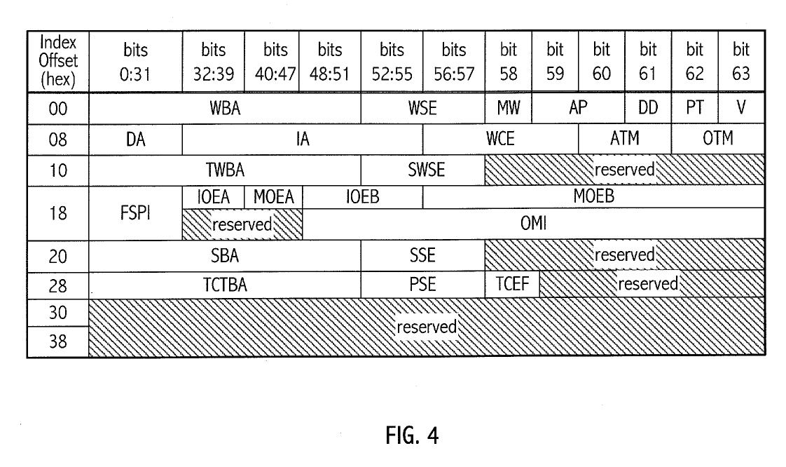

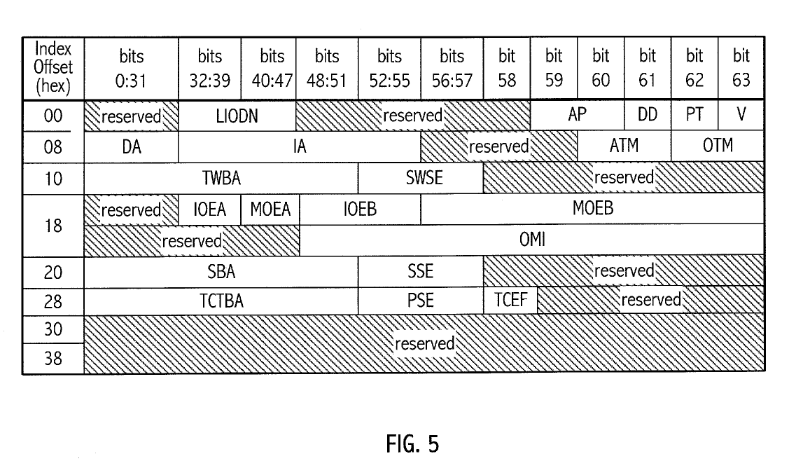

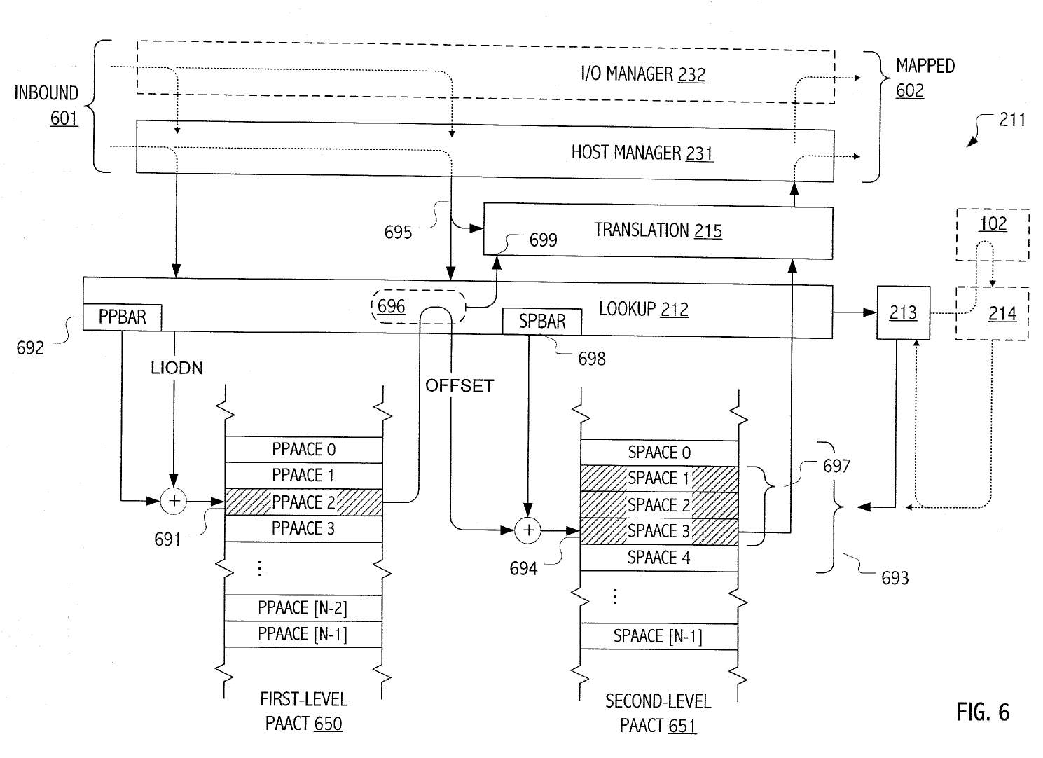

For purposes of illustration, FIG. 3 introduces use of primary PAACEs from a first-level PAACT. FIGS. 4 and 5 then illustrate structure of illustrative PAACE encodings suitable for use in some embodiments of the present invention. In particular, FIG. 4 illustrates fields of a PAACE encoding that may be pertinent to an inbound operation that corresponds (i) in some cases, to a primary sub-window of a DSA window that includes multiple sub-windows and (ii) in others, a DSA window that is not further decomposed into sub-windows. FIG. 5 illustrates fields of a PAACE encoding that may be pertinent to an inbound operation that corresponds to a secondary sub-window of a DSA window that includes multiple sub-windows. Thus, in some embodiments in which a hierarchy of table entries are employed, a first-level PAACT includes PAACEs in which fields are interpreted as shown in FIG. 4, while fields of PAACEs retrieved from a second-level PAACT are interpreted as shown in FIG. 5. FIG. 6 illustrates use of both primary and secondary PAACEs from respective first- and second-level PAACTs.

Turning first then to FIG. 3, we depict use of a first-level peripheral access authorization and control table (PAACT) by a peripheral access management unit (PAMU) in accordance with some embodiments of the present invention. In response to an inbound operation 301, whether originating from an I/O domain or coherence domain, lookup unit 212 is presented with information that codes or otherwise identifies (e.g., as a source or target) the logical I/O device number (LIODN) of the I/O domain-side logical device involved in the inbound operation. Using that LIODN as an offset into peripheral access authorization and control table (PAACT) 350, lookup unit 212 identifies a particular entry thereof, i.e., PAACE 391, which codes access authorization and control information together with address mapping information for at least a DSA window of address/identifier space associated with the logical I/O device involved in the operation (here, LIODN 2).

In the embodiment shown, first-level PAACT base address register 392 codes the base address (e.g., in memory 102) of PAACT 350, which in combination with the LIODN, identifies the corresponding PAACE. Other lookup mechanisms may be employed in other embodiments and, in general, lookups in cache 213 and fetches from memory 102 need not employ the same lookup mechanism. As illustrated in FIG. 3, contents of PAACT 350 may be retrieved from storage local to the PAMU, e.g., from cache 213. Alternatively, if no valid cached entry is available locally, fetch unit 214 may initiate a retrieval of at least the portion 393 of PAACT 350 that includes the identified PAACE (here, PAACE 391).

Using the information associated with inbound operation 301 (e.g., an in-bound read-type operation from an I/O domain that targets an address within an identified logical I/O device's DSA window), lookup unit 212 of PAMU 211 (recall, FIG. 2) obtains the corresponding primary PAACE from PAACT 350. Contents of the primary PAACE will indicate whether additional data structures need to be referenced to obtain the access authorization and translation attributes for inbound operation 301 given the particular logical I/O device and address(es) involved. For example, if the primary PAACE codes use of multiple sub-windows and if the targeted address is beyond the extent of the primary sub-window, a secondary PAACE associated with the corresponding secondary sub-window is accessed to obtain the access authorization and translation attributes. Alternatively, if the primary PAACE does not code use of multiple sub-windows or if the targeted address is within the primary sub-window, the primary PAACE is used to obtain access authorization and translation attributes. In some cases, such as when the operative PAACE indicates that a page address translation mode applies to inbound operation 301, additional information may be retrieved from a translation control entry coded in a translation control table (TCT). Similarly, in embodiments that support operation translation, additional information to support certain indexed translation modes may be retrieved from an operation mapping table (OMT). Like the PAACTs, TCTs and OMTs are maintained in memory (e.g., memory 102) by supervisory code and are coherently cached by PAMU 211.

Assuming, relative to the illustration of FIG. 3, that PAACE 391 does not code use of multiple sub-windows (or if it does, that the targeted address is within the primary sub-window), lookup unit 212 obtains access authorization and translation attributes pertinent to inbound operation 301 from PAACE 391 itself. Translation unit 215 performs applicable address translations in accord with a translation mode encoded in PAACE 391. In some embodiments, operation translations are also performed. In any case, a mapped operation 302 (including a target address and operation type) is supplied for forwarding to the destination domain (e.g., to memory 102 in coherency domain 124, recalling FIG. 2). To support the above-described operation of PAMU 211, encodings of peripheral access authorization and control entries support a rich and customizable set of translations for addresses and operations alike. Address translation codings and corresponding translation modes for PAMU 211 are described in greater detail below with reference to FIGS. 4 and 5, while operation translation codings and modes of operation are detailed in previously incorporated U.S. application Ser. No. ______ {Docket No. NM45493THX}.

FIG. 4 depicts an illustrative coding of peripheral access authorization and control entries (PAACEs) suitable for use, in accordance with some embodiments of the present invention, as a logical I/O device specific entry in a first-level peripheral access authorization and control table PAACT. In particular, PAACE 401 illustrates an encoding of a window base address field WBA that specifies, relative to a specific logical I/O device, the base address of the corresponding DSA window in I/O interconnect space. In some embodiments, field WBA encodes (up to) the 52 most-significant bits of a 64-bit address, aligned to a 4 KB page boundary and aligned to the window size encoding field WSE. In the illustrated coding, fields WBA and WSE together define a 2^{(WSE+1)} Byte span for a DSA window beginning at the WBA field encoded base address. Thus, lookup unit 212 (recall FIG. 3) compares an address target of inbound operation 301 against the DSA window span, signaling a violation if appropriate. By approaching the full address-width employed in coherency domain 124, WBA field encodings allow some embodiments to specify “no-translation” address translations modes for some accesses. In any case, lesser-width WBA field encodings may be employed in some embodiments.

The multiple windows field MW (shown in PAACE 401) is used to indicate whether multiple sub-windows exist within the logical I/O device specific DSA window and, if so, the number of equally-sized sub-windows is coded in the window count encoding WCE field, where (in the illustrated embodiment) the sub-window count so encoded is 2^{(WCE+1)}. Thus, lookup unit 212 (recall FIG. 3) further compares an address target of inbound operation 301 against the sub-window decomposition (if any) established by field WCE and places the address within a particular sub-window. If address target falls within the first such sub-window (consistent with contents of the sub-window sub-range encoding SWSE field), then pertinent access authorization and translation control codings appear in this PAACE instance (i.e., that described with reference to PAACE 401). On the other hand, if the address target falls within a subsequent sub-window, then lookup unit 212 uses the first secondary PAACE index field FSPI (coded within PAACE 401) to identify the location (within a second-level PAACT) at which secondary PAACEs are encoded for the second and subsequent sub-windows. FIG. 5 depicts an illustrative coding format 501 for secondary PAACEs.

Turning to FIG. 6, we depict use of first- and second-level peripheral access authorization and control tables (PAACTs) by a peripheral access management unit (PAMU) in accordance with some embodiments of the present invention. In response to an inbound operation 601, whether originating from an I/O domain or coherence domain, lookup unit 212 is presented with information that codes or otherwise identifies (e.g., as a source or target) the logical I/O device number (LIODN) of the I/O domain-side logical device involved in the inbound operation as well as a target address 695 in the DSA window corresponding to that LIODN. Using that LIODN as an offset into first-level PAACT 650, lookup unit 212 identifies a particular entry thereof, i.e., primary PAACE 691, which codes access authorization and control information together with address mapping information a primary sub-window of address/identifier space associated with the logical I/O device involved in the operation.

In the embodiment shown, first-level PAACT base address register 692 codes the base address of PAACT 650, which in combination with the LIODN, identifies the corresponding primary PAACE 691. Contents of primary PAACE 691 code fields that determine how PAMU 211 evaluates access authorization controls and translations for at least a portion of the logical I/O device's DSA window. Included in primary PAACE 691 are the previously described base address WBA and window size encoding WSE fields that together specify, relative to the logical I/O device, the base and span of the corresponding DSA window. In the illustrated case, the multiple windows MW and window count encoding WCE fields (also coded in primary PAACE 691) indicate that the logical I/O device specific DSA window contains four (4) equally-sized sub-windows. Accordingly, upon comparison of address target 695 of inbound operation 601 with the PAACE 691 encoded sub-window decomposition, lookup unit 212 places the address target within the fourth sub-window. Also coded in primary PAACE 691 is the previously described field FSPI which codes an index within second-level PAACT 651 at which secondary PAACEs 697 (here, SPAACE 1, SPAACE 2 and SPAACE 3) for the second, third and fourth sub-windows appear. Using the field FSPI and its placement (consistent with contents of the WCE field) of the address target within the fourth sub-window, lookup unit 212 determines (696) an effective offset (OFFSET) into second-level PAACT 651. Secondary PAACT base address register 698 codes the base address (e.g., in memory 102) of PAACT 651.

Using the base address and offset, lookup unit 212 obtains and supplies translation unit 215 with the secondary PAACE 694 that codes access authorization and translation controls pertinent to the fourth sub-window of the logical I/O device specific DSA window in which target address 695 is placed. Note that if target address 695 had instead been placed in the first sub-window, primary PAACE 691 would code the pertinent access authorization and translation controls and lookup unit 212 could have supplied translation unit 215 with contents of primary PAACE 691 without retrieval of a secondary PAACE from second-level PAACT 651. In short, primary PAACE 691 and secondary PAACEs 697 together code individually with respect to their respective sub-windows access authorization and translation control attributes that define operation of PAMU 211, and in particular, address translations performed by translation unit 215. Accordingly, operation of PAMU 211 in general and translation unit 215 in particular will be understood with reference to attributes coded for a particular logical I/O device in its PAACEs.

As previously explained, FIG. 4 depicts an illustrative coding of a primary PAACE suitable for use as a logical I/O device specific entry in a first-level PAACT. FIG. 5 likewise depicts an analogous coding for secondary PAACEs suitable for use as entries in a second-level PAACT. In the illustrated codings, similar or identical codings for certain access authorization and translation controls are employed in both primary and secondary PAACEs (i.e., in PAACEs in accord with either FIG. 4 or FIG. 5). Accordingly, although field codings and related operation of PAMU 211 and translation unit 215 are described with reference FIG. 5 and to secondary PAACE lookup consistent with FIG. 6, persons of ordinary skill in the art will appreciate that much of the description is also applicable to situations (such as that illustrated in FIG. 3) in which a given access is governed by contents of a primary PAACE coded in accord with FIG. 4.

Turning then to FIG. 5, an access permissions AP field codes whether access by an inbound operation associated with the corresponding sub-window is permitted and, if permitted, the type(s) of accesses permitted. An address translation mode ATM field codes whether address translation is enabled for address targets of an inbound operation associated with the corresponding sub-window and, if so, the type of address translation to perform. In embodiments that support operation translations, an operation translation mode OTM field codes whether operation translation is enabled for an inbound operation associated with the corresponding sub-window and, if so the type of translation to perform. Access permissions and address translations are described in greater detail below, while operation translations are detailed in previously incorporated U.S. application Ser. No. ______ {Docket No. NM45493THX}. Note that the previously introduced sub-window sub-range encoding SWSE field codes the portion (potentially less than all) of the corresponding sub-window for which mappings (e.g., address translations, operation translations, etc.) are supported.

In general, any of a variety of permission sets and address translation modes may be coded in accord with the needs of a given computational system and, as previously described, particular sub-window specific selections are typically maintained by supervisory code (e.g., by a hypervisor or partition manager in a virtualized or partitioned computational system). Therefore, for purposes of illustration only and without limitation, some PAACE encodings in accord with formats 401, 501 allow selection (using the field AP) of sub-window specific permissions from a set that includes (i) denied, (ii) query only, (iii) update only and (iv) permitted for all operation types.

Similarly, and again only for purposes of illustration and without limitation, some PAACE encodings allow selection (using the field ATM illustrated in formats 401, 501) of sub-window specific address translation modes from a set that includes (i) no translation, (ii) window only translation, (iii) page only translation and (iv) window and page translation. For an inbound operation 601 that maps (based on lookup of the associated PAACE by lookup unit 212) as a window only translation, translation unit 215 uses a base address coded in the translated window base address TWBA field of the associated PAACE as a base for the translated address supplied as part of mapped operation 602. Window only translation directs translation unit 215 to map those DSA operation targets that fall within particular sub-window to a contiguous window of the same size in system storage (e.g., memory 102), wherein the contiguous window begins at an address specified by the TWBA field of the associated PAACE. In this way, the DSA window can be located anywhere in the I/O interconnect address space including an address range where the addressing width of the I/O interconnect address space is larger than that defined for system storage space. In general, depending on the particular TWBA field values established for different logical I/O devices and/or different sub-windows, the mapped-to ranges of addresses in system storage space may overlap.

With respect to an inbound operation 601 that maps as a page only translation, lookup unit 212 uses a base address coded in the translation control table base address TCTBA field and a page size encoding PSE field of the associated PAACE to facilitate further retrieval of page-level address translation information from a translation control table (TCT). In particular, lookup unit 212 retrieves an appropriate translation control entry (TCE) using contents of fields TCTBA and PSE to identify an appropriate TCE that itself codes page-specific address translations and access-permissions corresponding to a page address portion of the target address 695 associated with inbound operation 601. Using a translated page address retrieved from the corresponding TCE together with an offset derived from the target address 695, translation unit 215 supplies the translated address for mapped operation 602. In this way, addresses within a particular sub-window can be mapped on a page-level granularity to locations within system storage space. In general, depending on the particular contents of translation control entries established for different logical I/O devices and/or different sub-windows, the mapped-to pages may be arbitrarily distributed throughout system storage space, including with overlap if desired. Note that in some embodiments including some embodiments that seek to support PCI addressing models and legacy 32-bit devices, only a portion of the I/O interconnect address space, e.g., that below a 4 GB boundary may be subject to page translations.

Additional address translation modes are supported in some embodiments. For example, in some embodiments, the field ATM may code for a particular sub-window that no translations are to be performed and that a target address 695 is to be passed through to the mapped operation 602 without translation. Similarly, in some embodiments a combined, window and page translation mode may be supported in which a section of a DSA window (e.g., up to a 4 GB portion thereof) covered by a given PAACE is mapped using page translations coded in a translation control table as previously described, while the remainder of the sub-window is mapped as described above with respect to the window only translation mode. In the PAACE formats illustrated in FIGS. 4 and 5, section base address SBA and section size encoding SSE fields delimit the section for which page translations are to be performed by translation unit 215.

### Specialized and Storage Efficient Mappings

Given the foregoing, it will be apparent to persons of ordinary skill in the art that computational systems that employ peripheral access management techniques such as described herein with reference to PAMU 211 (recall FIG. 2) and memory resident first- and second level PAACTs that code address translations with respect to individual logical I/O devices and sub-windows of I/O address space (recall FIGS. 3-6) provide a flexible mechanism for specializing mappings to the individual needs of many disparate devices, virtualization schemes and/or use patterns. Mappings between I/O and host domains can be established by supervisory code in ways that allow fine-grained flexibility in the form, granularity and/or extent of mappings, attributes and access controls coded relative to a particular I/O domain. Indeed, different address translation models may be employed on a per-logical-device (or even a per-sub-window) basis. In general, this flexibility can be desirable, particularly as numbers of I/O domains increase, such as in the case of virtualization system implementations in which a multiplicity of logical I/O devices may be represented using underlying physical resources.

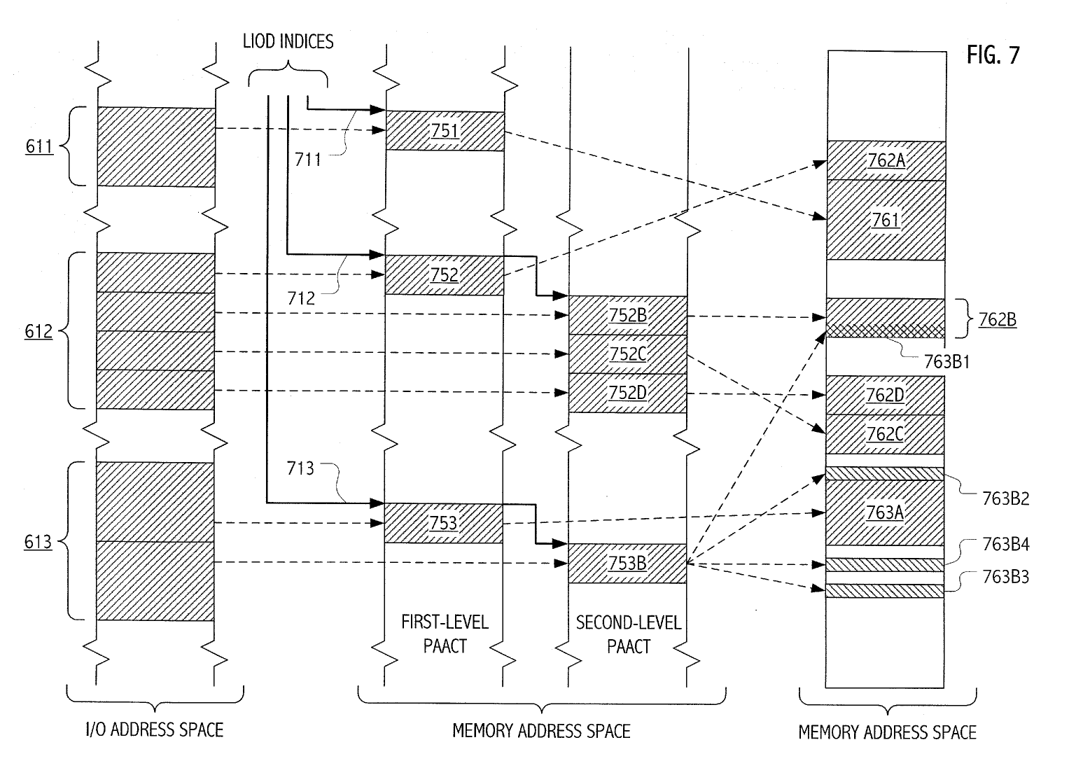

Rather than attempting to create a unified set of access, authorization and/or control information for mappings between all I/O and host domains (or even a unified mapping for subsets of the I/O domains corresponding to logical I/O devices supported using common underlying resources), each logical I/O device may be supported with information that need only encode that pertinent thereto and then, only in a manner that is useful or efficient for the particular logical I/O device and its relevant mappings. Accordingly, as illustrated in FIG. 7, portions of I/O address space corresponding to three different logical I/O devices (shown as DSA windows 611, 612 and 613, respectively) may be mapped using differing granularities and extents which are appropriate to their individual needs.

Logical I/O device numbers (LIODNs) are used as indices 711, 712 and 713 into a primary peripheral access authorization control table (PAACT) that includes peripheral access authorization control entries (PAACEs) 751, 752 and 753 that include (for respective logical I/O devices) the WBA and WSE field encoded bases and extents (recall FIG. 4) that correspond to DSA windows 611, 612 and 613, respectively. In addition, PAACEs 751, 752 and 753 include (for respective logical I/O devices) the MW and WCE field encoded multiple sub-window flag and sub-window counts that correspond to DSA windows 611, 612 and 613, respectively. In particular, in the illustration of FIG. 7, DSA window 611 is generally smaller than DSA windows 612 and 613 and includes only a primary (sub-)window, whereas DSA windows 612 and 613 include four (4) and two (2) sub-windows respectively. Thus, in a PAMU configuration using PAACT and PAACE coded access authorization and translation controls such as illustrated, individual logical I/O devices are supported with differing granularities and extents.

Using only the single-level primary PAACE 751 encoding, a computational system codes a window only address mapping to a corresponding contiguous window 761 in memory address space. Using a primary PAACE 752 together with secondary PAACEs 752B, 752C and 752D, the computational system codes dissimilar window only address mappings to a generally discontiguous set of corresponding sub-windows 762A, 762B, 762C and 762D in memory address space. Finally, using a primary PAACE 753 together with a secondary PAACE 753B (and a translation control table encoding not separately shown), the computational system codes a window only address mapping for the first sub-window of DSA window 613 to sub-windows 762A in system address space, together with a page-oriented set of mapping for the second sub-window of DSA window 613 to pages 763B1, 763B2, 763B3 and 763B4 in system address space.

In some systems that incorporate embodiments of the present invention, the ability to encode access, authorization and/or control information on a per-logical device basis (or even a per-sub-window basis within a given I/O domain) facilitates coding of the mappings in ways that are, in aggregate, quite storage-efficient as the coding for one I/O domain need not be fettered by complexity necessary or desirable only for another and since no grand unification of mappings is necessary. In short, by defining mapping data structure(s) in a way that allows differing complexity, granularity and/or extent of mapping for individual logical I/O domains, system implementations need not code all mappings in accord with requirements of the most complex or storage intense. In this way, scaling of overall storage requirements may be managed in access management system implementations. In addition, in some embodiments, the form of mappings (e.g., address) may be specialized on a per-logical-device basis (or per-sub-window basis), thereby offering individual logical I/O domains (or sub-windows thereof) paged, windowed, mixed, and/or un-translated mapping frameworks appropriate to their individual requirements or needs.

### EXAMPLES

In some embodiments, a method of mapping identifiers from a plurality of device-specific input/output (I/O) domains to respective identifiers in a host domain includes maintaining in storage accessible to an input/output (I/O) memory management unit, a set of first-level table entries each coding access information for a respective logical device and corresponding to at least a portion of an I/O domain associated therewith, wherein the I/O domains associated with at least some of the logical devices are further decomposed into a plurality of subwindows. The method further includes maintaining in the accessible storage a set of second-level table entries each coding access information corresponding to respective ones of the subwindows, if any, for a particular I/O domain, wherein those of the second-level table entries, if any, corresponding to a particular I/O domain, code access information for less than all subwindows thereof. The method further includes mapping identifiers corresponding to a first subwindow of a first, device-specific I/O domain using a first one of the first-level table entries; mapping identifiers corresponding to at least some remaining subwindows of the first, device-specific I/O domain using respective second-level table entries identifiable via the first, first-level table entry; and mapping identifiers corresponding to at least a portion of a second, device-specific I/O domain using a second one of the first-level table entries.

In some embodiments, such a method further provides that, in addition to the access information coded therein, the first- and second-level table entries code for each associated subwindow an address translation mode. In some embodiments, such a method further provides that, the mapping of identifiers corresponding to one subwindow of the first device-specific I/O domain is in accordance with a window-based address translation mode; and the mapping of identifiers corresponding to another subwindow of the first device-specific I/O domain is in accordance with a page-based address translation mode.

In some embodiments, for respective ones of the device-specific I/O domains, the mappings of identifiers are in accordance with respective address translation modes coded therefor, and the address translation modes coded for at least one subwindow of the first device-specific I/O domains and for at least one subwindow of a third device-specific I/O domain differ. In some such embodiments, the differing address translation modes are individually selected from a set of modes that includes a window-based translation mode and a page-based translation mode. In some such embodiments, the differing address translation modes are individually selected from a set of modes that includes a no translation mode, a page address translation mode, a window-only address translation mode and a mode in which some addresses of a particular device-specific I/O domain are translated in accord with a page translation technique and other addresses within the particular device-specific I/O domain are translated in accord with a window translation technique.

In some embodiments, identifiers corresponding to respective subwindows of the second, device-specific I/O domain map to discontiguous portions of the host domain in accordance with mappings coded in respective ones of the first- and second-level table entries, and identifiers corresponding to the second, device-specific I/O domain is to a contiguous portion of the host domain in accordance with mappings coded in the second first-level table entry. In some embodiments, the second first-level table entry maps the entirety of the second, device-specific I/O domain.

In some embodiments, the second first-level table entry maps identifiers corresponding to a first subwindow of the second, device-specific I/O domain, and the method further includes mapping identifiers corresponding to at least some remaining subwindows of the second, device-specific I/O domain using respective second-level table entries identifiable via the second, first-level table entry. In some such embodiments, sub-windows of the first and second device-specific I/O domains are defined at differing granularities.

In some embodiments, the table entries for first and second device-specific I/O domains code different window extents. In some embodiments, at least a portion of the first and the second device-specific I/O domains map via respective but distinct table entries to a same portion of the host domain. In some embodiments, the table entries code both I/O to host domain mappings and host to I/O domain mappings.

In some embodiments, a method of managing mappings between a plurality of device-specific input/output (I/O) domains and a coherency domain includes instantiating in storage accessible to an I/O memory management unit a mapping data structure that defines for at least some of the device-specific I/O domains two-levels of mapping table entries; and individually varying granularity of mappings for each of the device-specific I/O domains by coding in an associated first-level table entry of the mapping data structure whether and, if so, how many, subwindows are coded for the associated device-specific I/O domain.

In some embodiments, such a method further includes, for a particular device-specific I/O domain, coding mapping information for a first of the subwindows in the associated first-level table entry and coding mapping information for remaining ones of the subwindows in respective second-level table entries identifiable via the associated first-level table entry. In some embodiments, such a method further includes, for at least some of the device-specific I/O domains, defining only a first-level table entry of the mapping data structure. In some embodiments, such a method further includes, individually varying a mapped extent for respective device-specific I/O domains by coding a window size in the respective first-level table entry of the mapping data structure. In some embodiments, such a method further includes, for a first of the device-specific I/O domains for which two-levels of mapping table entries are defined, defining a first subwindow size; and for a second of the device-specific I/O domains for which two-levels of mapping table entries are defined, defining a second subwindow size, the second subwindow size differing from the first.

In some embodiments, an apparatus includes a peripheral access management unit for coupling between storage and I/O resources to map from a plurality of logical device-specific I/O domains to respective locations in a coherent memory domain. The peripheral access management unit is configured to manage I/O accesses using a set of first-level table entries each coding access and address mapping information for a respective logical device and corresponding to at least a portion of an I/O domain associated therewith. I/O domains associated with at least some of the logical devices are further decomposed into a plurality of subwindows, the peripheral access management unit further configured to manage I/O accesses for a particular one of the further decomposed I/O domains using, for a primary subwindow thereof, the corresponding first-level table entry and, for respective secondary subwindows thereof, a set of second-level table entries each coding access information and address mapping for a respective one of the secondary subwindows.

In some embodiments, such an apparatus further includes storage for the first- and second-level table entries, the storage accessible to the peripheral access management unit. At least one of the I/O domains is decomposed at a different subwindow granularity than another, and respective table entries code, for identifiers within respective subwindows of associated I/O domains, different address translation modes selected from an available set thereof that includes at least one window-based address translation mode and at least one page-based address translation mode.

### Other Embodiments

Although the invention is described herein with reference to specific embodiments, various modifications and changes can be made without departing from the scope of the present invention as set forth in the claims below. For example, while techniques have been described in the context of particular peripheral access management unit configurations, the described techniques have broad applicability to mappings between identifier domains. Similarly, although the described techniques may be employed to facilitate efficient use address spaces and efficient codings of access authorization and translation controls, the techniques are not limited thereto.

Embodiments of the present invention may be implemented using any of a variety of different information processing systems. Accordingly, while FIG. 1 together with its accompanying description relates to an exemplary partitionable multiprocessor-type information processing architecture with a coherent multi-path interconnect fabric, the exemplary architecture is merely illustrative. While illustrations have tended to focus on a peripheral access management unit (PAMU)-type implementation by which a multiplicity of logical I/O devices and domains may be supported using underlying physical resources, such implementations may include support for a range of variations in form, granularity and/or extent of mappings as well as support for access and authorization controls that need not be included in all embodiments. Instead, based on the description herein persons of ordinary skill in the art will appreciate applications of the invented techniques to other access management systems (including those styled as MMUs, PAMUs, IOMMUs, etc.) and computational systems with or without virtualization, multiprocessor support or partitionable aspects. Of course, architectural descriptions herein have been simplified for purposes of discussion and those skilled in the art will recognize that illustrated boundaries between logic blocks or components are merely illustrative and that alternative embodiments may merge logic blocks or circuit elements and/or impose an alternate decomposition of functionality upon various logic blocks or circuit elements.

Articles, systems and apparati that implement the present invention are, for the most part, composed of electronic components, circuits and/or code (e.g., software, firmware and/or microcode) known to those skilled in the art and functionally described herein. Accordingly, component, circuit and code details are explained at a level of detail necessary for clarity, for concreteness and to facilitate an understanding and appreciation of the underlying concepts of the present invention. In some cases, a generalized description of features, structures, components or implementation techniques known in the art is used so as to avoid obfuscation or distraction from the teachings of the present invention.

In general, the terms “program” and/or “code” are used herein to describe a sequence or set of instructions designed for execution on a computer system. As such, such terms may include or encompass subroutines, functions, procedures, object methods, implementations of software methods, interfaces or objects, executable applications, applets, servlets, source, object or intermediate code, shared and/or dynamically loaded/linked libraries and/or other sequences or groups of instructions designed for execution on a computer system.

Finally, the specification and figures are to be regarded in an illustrative rather than a restrictive sense, and consistent with the description herein, a broad range of variations, modifications and extensions are envisioned. Any benefits, advantages, or solutions to problems that are described herein with regard to specific embodiments are not intended to be construed as a critical, required, or essential feature or element of any or all the claims.

What is claimed is:

1. A method of mapping identifiers from a plurality of device-specific input/output (I/O) domains to respective identifiers in a host domain, the method comprising:
maintaining in storage accessible to an input/output (I/O) memory management unit a set of first-level table entries each coding access information for a respective logical device and corresponding to at least a portion of an I/O domain associated therewith, wherein the I/O domains associated with at least some of the logical devices are further decomposed into a plurality of subwindows;
maintaining in the accessible storage a set of second-level table entries each coding access information corresponding to respective ones of the subwindows, if any, for a particular I/O domain, wherein those of the second-level table entries, if any, corresponding to a particular I/O domain, code access information for less than all subwindows thereof;
mapping identifiers corresponding to a first subwindow of a first, device-specific I/O domain using a first one of the first-level table entries;
mapping identifiers corresponding to at least some remaining subwindows of the first, device-specific I/O domain using respective second-level table entries identifiable via the first, first-level table entry; and
mapping identifiers corresponding to at least a portion of a second, device-specific I/O domain using a second one of the first-level table entries.

2. The method of claim 1,
wherein, in addition to the access information coded therein, the first- and second-level table entries code for each associated subwindow an address translation mode.

3. The method of claim 2,
wherein the mapping of identifiers corresponding to one subwindow of the first device-specific I/O domain is in accordance with a window-based address translation mode; and
wherein the mapping of identifiers corresponding to another subwindow of the first device-specific I/O domain is in accordance with a page-based address translation mode.

4. The method of claim 1,
wherein for respective ones of the device-specific I/O domains, the mappings of identifiers are in accordance with respective address translation modes coded therefor, and
wherein the address translation modes coded for at least one subwindow of the first device-specific I/O domains and for at least one subwindow of a third device-specific I/O domain differ.

5. The method of claim 4, wherein the differing address translation modes are individually selected from a set of modes that includes:
a window-based translation mode; and
a page-based translation mode.

6. The method of claim 4, wherein the differing address translation modes are individually selected from a set of modes that includes:
a no translation mode;
a page address translation mode;
a window-only address translation mode; and
a mode in which some addresses of a particular device-specific I/O domain are translated in accord with a page translation technique and other addresses within the particular device-specific I/O domain are translated in accord with a window translation technique.

7. The method of claim 1,
wherein identifiers corresponding to respective subwindows of the second, device-specific I/O domain map to discontiguous portions of the host domain in accordance with mappings coded in respective ones of the first- and second-level table entries, and
wherein the mapping of identifiers corresponding to the second, device-specific I/O domain is to a contiguous portion of the host domain in accordance with mappings coded in the second first-level table entry.

8. The method of claim 1,
wherein the second first-level table entry maps the entirety of the second, device-specific I/O domain.

9. The method of claim 1, wherein the second first-level table entry maps identifiers corresponding to a first subwindow of the second, device-specific I/O domain, the method further comprising:
mapping identifiers corresponding to at least some remaining subwindows of the second, device-specific I/O domain using respective second-level table entries identifiable via the second, first-level table entry.

10. The method of claim 9,
wherein sub-windows of the first and second device-specific I/O domains are defined at differing granularities.

11. The method of claim 1,
wherein the table entries for first and second device-specific I/O domains code different window extents.

12. The method of claim 1,
wherein at least a portion of the first and the second device-specific I/O domains map via respective but distinct table entries to a same portion of the host domain.

13. The method of claim 1,
wherein the table entries code both I/O to host domain mappings and host to I/O domain mappings.

14. A method of managing mappings between a plurality of device-specific input/output (I/O) domains and a coherency domain, the method comprising:
instantiating in storage accessible to an I/O memory management unit a mapping data structure that defines for at least some of the device-specific I/O domains two-levels of mapping table entries; and
individually varying granularity of mappings for each of the device-specific I/O domains by coding in an associated first-level table entry of the mapping data structure whether and, if so, how many, subwindows are coded for the associated device-specific I/O domain.

15. The method of claim 14, further comprising:
for a particular device-specific I/O domain, coding mapping information for a first of the subwindows in the associated first-level table entry and coding mapping information for remaining ones of the subwindows in respective second-level table entries identifiable via the associated first-level table entry.

16. The method of claim 14, further comprising:
for at least some of the device-specific I/O domains, defining only a first-level table entry of the mapping data structure.

17. The method of claim 14, further comprising:
individually varying a mapped extent for respective device-specific I/O domains by coding a window size in the respective first-level table entry of the mapping data structure.

18. The method of claim 14, further comprising:
for a first of the device-specific I/O domains for which two-levels of mapping table entries are defined, defining a first subwindow size; and
for a second of the device-specific I/O domains for which two-levels of mapping table entries are defined, defining a second subwindow size, the second subwindow size differing from the first.

19. An apparatus comprising:
a peripheral access management unit for coupling between storage and I/O resources to map from a plurality of logical device-specific I/O domains to respective locations in a coherent memory domain,
the peripheral access management unit configured to manage I/O accesses using a set of first-level table entries each coding access and address mapping information for a respective logical device and corresponding to at least a portion of an I/O domain associated therewith,
wherein I/O domains associated with at least some of the logical devices are further decomposed into a plurality of subwindows, the peripheral access management unit further configured to manage I/O accesses for a particular one of the further decomposed I/O domains using:
for a primary subwindow thereof, the corresponding first-level table entry; and
for respective secondary subwindows thereof, a set of second-level table entries each coding access information and address mapping for a respective one of the secondary subwindows.

20. The apparatus of claim 19, further comprising:
storage for the first- and second-level table entries, the storage accessible to the peripheral access management unit,
wherein at least one of the I/O domains is decomposed at a different subwindow granularity than another, and
wherein respective table entries code, for identifiers within respective subwindows of associated I/O domains, different address translation modes selected from an available set thereof that includes at least one window-based address translation mode and at least one page-based address translation mode.
